(19) United States
(12) Patent Application Publication
(10) Pub. No.: US 2025/0174380 A1
(43) Pub. Date: May 29, 2025

(54) MULTILAYER VARISTOR

(71) Applicant: Panasonic Intellectual Property Management Co., Ltd., Osaka (JP)

(72) Inventors: Yuto AKIYAMA, Hokkaido (JP); Sayaka WATANABE, Hokkaido (JP); Daiki TAKAHASHI, Hokkaido (JP)

(21) Appl. No.: 18/958,905

(22) Filed: Nov. 25, 2024

(30) Foreign Application Priority Data
Nov. 29, 2023 (JP) 2023-202033

(51) Int. Cl. H01C 7/12; H01C 1/142

(52) U.S. Cl. CPC H01C 7/12; H01C 1/142

(57) ABSTRACT

A multilayer varistor includes: a sintered compact including a plurality of layers stacked in a stacking direction; a first internal electrode disposed on a first disposing surface in the sintered compact; a second internal electrode disposed on a disposing surface different from the first disposing surface in the sintered compact, the second internal electrode overlapping at least part of the first internal electrode in the stacking direction; and a third internal electrode disposed on a disposing surface different from the first disposing surface in the sintered compact, the third internal electrode overlapping at least part of the first internal electrode in the stacking direction. A length of the first internal electrode in the stacking direction is greater than a length of each of the second internal electrode and the third internal electrode in the stacking direction.

### CROSS-REFERENCE TO RELATED APPLICATION

The present application is based upon, and claims the benefit of priority to, Japanese Patent Application No. 2023-202033, filed on Nov. 29, 2023, the entire contents of which are hereby incorporated by reference.

### TECHNICAL FIELD

The present disclosure relates to multilayer varistors and specifically relates to a multilayer varistor including three or more internal electrodes.

### BACKGROUND ART

Multilayer varistors have been used to, for example, protect various types of electronic equipment and electronic devices from an abnormal voltage generated by lighting surge or static electricity, for example, and prevent the various types of electronic equipment and electronic devices from malfunctioning due to noise generated in a circuit.

A multilayer varistor having a 2-in-1-structure, that is, including two varistor elements formed in one multilayer varistor has been proposed. JP H07-235406 A discloses a chip capacitive varistor, as a multilayer varistor having the 2-in-1 structure, including: a sheet-shaped base containing a voltage nonlinear resistance ceramic material; and a plurality of pairs of internal electrodes between which the base is sandwiched, wherein at least one internal electrode included in each of the plurality of pairs is electrically out of contact with an internal electrode included in another one of the plurality of pairs.

In multilayer varistors having a conventional 2-in-1 structure as described in JP H07-235406 A, reception of a surge by the two varistor elements at the same time may lead to an increased density of a current flowing through the internal electrodes, thereby causing burned-out internal electrodes or degradation of the varistor elements due to local heat generation, which may result in reduced surge resistance.

### SUMMARY

It is an object of the present disclosure to provide a multilayer varistor having surge resistance suppressed from decreasing even when the multilayer varistor receives a plurality of surges at the same time.

A multilayer varistor according to an aspect of the present disclosure includes: a sintered compact including a plurality of layers stacked in a stacking direction; a first internal electrode disposed on a first disposing surface in the sintered compact; a second internal electrode disposed on a disposing surface different from the first disposing surface in the sintered compact, the second internal electrode overlapping at least part of the first internal electrode in the stacking direction; and a third internal electrode disposed on a disposing surface different from the first disposing surface in the sintered compact, the third internal electrode overlapping at least part of the first internal electrode in the stacking direction. A length of the first internal electrode in the stacking direction is greater than a length of each of the second internal electrode and the third internal electrode in the stacking direction.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1A is a transparent perspective view schematically illustrating a multilayer varistor according to an embodiment of the present disclosure;

FIG. 1B is a sectional view of the multilayer varistor along line A-A of FIG. 1A;

FIG. 2 is a schematic sectional view of a multilayer varistor of a variation of the present disclosure;

FIG. 3 is a schematic sectional view of a multilayer varistor of another variation of the present disclosure; and

FIG. 4 is a schematic sectional view of a multilayer varistor of another variation of the present disclosure.

### DETAILED DESCRIPTION

### 1. Overview

A multilayer varistor according to an embodiment of the present disclosure will now be described with reference to the accompanying drawings. Figures to be referred to in the following description of the embodiment are schematic representations. Thus, the ratio of the dimensions (including thicknesses) of respective constituent elements illustrated in the figures does not always reflect their actual dimensional ratio. Moreover, in each of the figures, a “stacking direction” which is a direction in which a plurality of layers are stacked in a sintered compact 11 is a z direction.

As a result of extensive studies on configurations of the multilayer varistor having the 2-in-1 structure, the present inventors found that a relative relationship between dimensions of the plurality of internal electrodes relates to a reduction in surge resistance, and thereby, the present inventors accomplished the present disclosure.

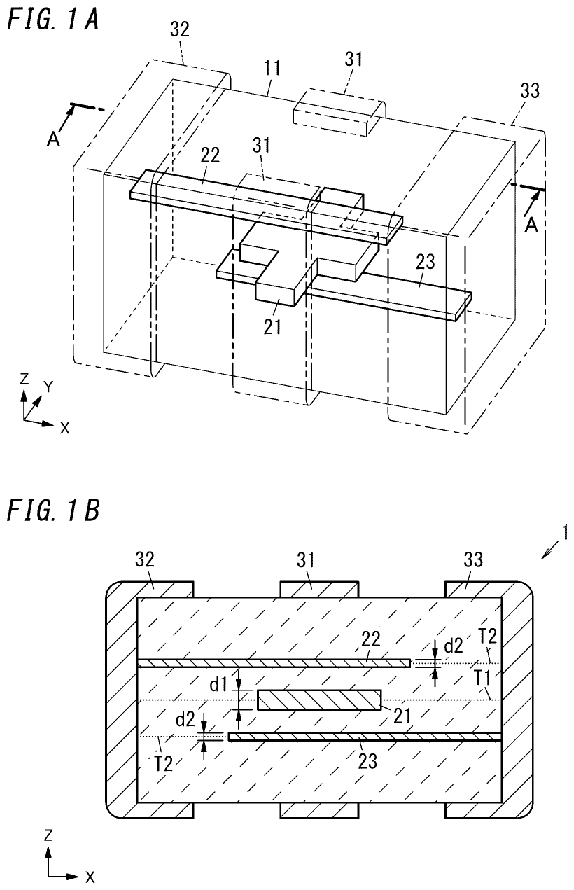

As shown in FIG. 1A, a multilayer varistor 1 of the present embodiment includes a sintered compact 11 and includes a first internal electrode 21, a second internal electrode 22, and a third internal electrode 23 as internal electrodes. The first internal electrode 21, the second internal electrode 22, and the third internal electrode 23 are disposed in the sintered compact 11.

As shown in FIG. 1B, the first internal electrode 21 is disposed on a first disposing surface T1, the second internal electrode 22 is disposed on a disposing surface T2 different from the first disposing surface T1, and the third internal electrode 23 is disposed on a disposing surface T2 different from the first disposing surface T1.

In the stacking direction, the second internal electrode 22 overlaps at least part of the first internal electrode 21, and the third internal electrode 23 overlaps at least part of the first internal electrode 21. As used herein “overlap in the stacking direction” means that two targets (the first internal electrode 21 and the second internal electrode 22, or the first internal electrode 21 and the third internal electrode 23) at least partially intersect each other when viewed in the stacking direction.

In the multilayer varistor 1 of the present embodiment, a length d1 of the first internal electrode 21 in the stacking direction is greater than a length d2 of each of the second internal electrode 22 and the third internal electrode 23 in the stacking direction.

The multilayer varistor 1 of the present embodiment has the configuration described above and thus has surge resistance suppressed from decreasing even when the multilayer varistor receives a plurality of surges at the same time. The reason why the multilayer varistor 1 having the configuration described above provides the effect described above is presumably, for example, as follows. The multilayer varistor 1 includes the first internal electrode 21 and includes the second internal electrode 22 and the third internal electrode 23 which are provided on disposing surfaces different from the disposing surface on which the first internal electrode 21 is disposed, and at least part of the first internal electrode 21 overlaps at least part of the second internal electrode 22 and at least part of the third internal electrode 23 in the stacking direction. As described above, the multilayer varistor 1 includes: two varistor elements, namely, a varistor element including the first internal electrode 21 and the second internal electrode 22; and a varistor element including the first internal electrode 21 and the third internal electrode 23, and when both of the two varistor elements receive a surge at the same time, the density of a current flowing through the first internal electrode 21 shared by the two varistor elements may increase. However, in the multilayer varistor 1 of the present embodiment, the length d1 of the first internal electrode 21 in the stacking direction is greater than the length d2 of the second internal electrode 22 or the third internal electrode 23 in the stacking direction, that is, the first internal electrode 21 has a larger thickness than the second internal electrode 22 or the third internal electrode 23, and therefore, the density of the current flowing through the first internal electrode 21 can be further reduced. As a result, the surge resistance of the multilayer varistor can be suppressed from decreasing due to burned-out internal electrodes or degradation of the varistor elements due to local heat generation which highly possibly occurs in conventional multilayer varistors.

Thus, according to the present disclosure, the multilayer varistor has surge resistance suppressed from decreasing even when the multilayer varistor receives a plurality of surges at the same time.

### 2. Details

### Multilayer Varistor

### Embodiment

The multilayer varistor 1 of the present embodiment will be described in detail below. The multilayer varistor 1 shown in FIGS. 1A and 1B includes the sintered compact 11 and includes the first internal electrode 21, the second internal electrode 22, and the third internal electrode 23 as the internal electrodes. The multilayer varistor 1 includes, for example, external electrodes. As the external electrodes, the multilayer varistor 1 includes, for example, a first external electrode 31, a second external electrode 32, and a third external electrode 33. Components of the multilayer varistor 1 will be described below.

### (Sintered Compact)

The sintered compact 11 has a multilayer structure including a plurality of layers stacked along the stacking direction (the z direction) and is, for example, in the shape of a rectangular parallelepiped having long sides aligned with an x direction and is 0.5 to 3 mm in length, 0.3 to 2 mm in width, and 0.3 to 2 mm in height. When the sintered compact 11 is in the shape of a rectangular parallelepiped, the sintered compact 11 has two principal surfaces facing each other in the stacking direction (the z direction), two side surfaces facing each other in a y direction, and two end surfaces facing each other in the x direction. In the sintered compact 11, a side portion(s) of the rectangular parallelepiped may accordingly be beveled, or the side portion(s) of the sintered compact 11 may be rounded.

The sintered compact 11 is made of a semiconductor ceramic component with nonlinear resistance characteristic, for example. The sintered compact 11 may include, as the semiconductor ceramic component, for example, ZnO as a main component and at least one of, for example, Bi₂O₃, Pr₆O₁₁, CaCO₃, Co₂O₃, Cr₂O₃, MnO₂, or Sb₂O₃ as a sub-component. In the sintered compact 11, ZnO is sintered, and on the grain boundary thereof, at least part of the sub-component deposits. A grain boundary barrier formed between ZnO particles exhibits the nonlinear resistance characteristic. The sintered compact 11 is formed by, for example, sintering a plurality of ceramic sheets containing ZnO as a main component and stacked in the stacking direction.

### (Internal Electrode)

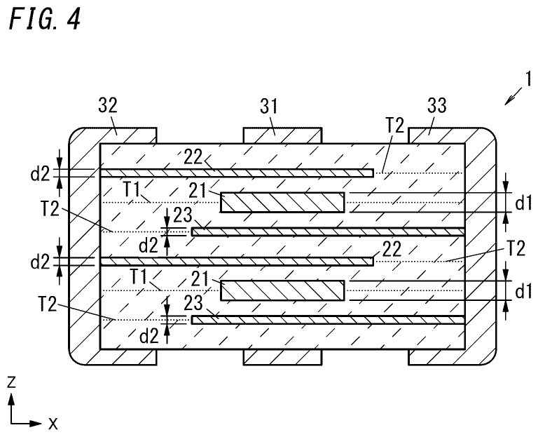

The multilayer varistor 1 includes the first internal electrode 21, the second internal electrode 22, and the third internal electrode 23 as the internal electrodes. The multilayer varistors 1 in FIGS. 1B, 2, and 3 each include one first internal electrode 21, one second internal electrode 22, and one third internal electrode 23. However, a multilayer varistor 1 may include two, or three or more, each of the internal electrodes 21, 22, and 23 as shown in FIG. 4.

The shape and the dimension of each of the internal electrodes 21, 22, and 23 in plan view are not limited to a particular shape and a particular dimension, but each of the internal electrodes 21, 22, and 23 has, for example, a rectangle or square shape in plan view and is in the shape of a flat plate having a length and a width of greater than or equal to 0.05 mm and less than or equal to 3 mm in plan view. Each internal electrode may have, for example, a cross shape or a T-shape in plan view.

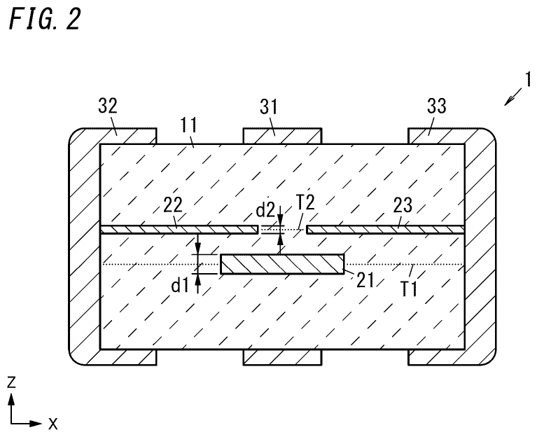

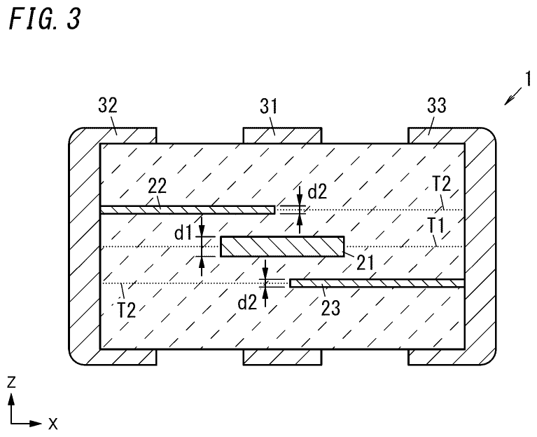

As shown in FIG. 1B, the first internal electrode 21 is disposed on the first disposing surface T1. The second internal electrode 22 and the third internal electrode 23 are disposed on the disposing surfaces T2 different from the disposing surface on which the first disposing surface T1 is disposed. The disposing surface T2 on which the second internal electrode 22 is disposed and the disposing surface T2 on which the third internal electrode 23 is disposed may be different from each other as shown in FIGS. 1B and 3, or may be the same as shown in FIG. 2.

The length d1 of the first internal electrode 21 in the stacking direction is greater than the length d2 of each of the second internal electrode 22 and the third internal electrode 23 in the stacking direction. As used herein, “length of the internal electrode in the stacking direction” means the thickness of the internal electrode and is an arithmetic mean value of thicknesses measured at a plurality of positions (e.g., 10 points) on the internal electrode.

As used herein, “d1 is greater than d2” means that d1 is greater than d2 by 10% or more, that is, d1 is 1.1 or more times d2. The length d1 of the first internal electrode 21 in the stacking direction is preferably 1.2 or more times, more preferably 1.5 or more times, much more preferably 2 or more times, and particularly preferably 2.3 or more times, the length d2 of each of the second internal electrode 22 and the third internal electrode 23 in the stacking direction. In this case, the surge resistance can be further suppressed from decreasing. Meanwhile, the length dl of the first internal electrode 21 in the stacking direction is preferably 5 or less times, more preferably 4 or less times, much more preferably 3 or less times, and particularly preferably 2.7 or less times the length d2 of each of the second internal electrode 22 and the third internal electrode 23 in the stacking direction. In this case, at the time of sintering for forming the internal electrodes, a large total thickness of the internal electrodes 21, 22, and 23 can suppress elements in the internal electrode from warping due to the difference in shrinkage ratio between the sintered compact and each internal electrode.

The first internal electrode 21 is preferably disposed between the second internal electrode 22 and the third internal electrode 23 in the stacking direction. Such a structure is a structure in which the current density of the first internal electrode 21 easily increases and heat is easily generated, and therefore, the benefit of employing the present disclosure is great.

At least part of the first internal electrode 21, at least part of the second internal electrode 22, and at least part of the third internal electrode 23 preferably overlap one another in the stacking direction. Such a structure is also a structure in which the current density of the first internal electrode 21 easily increases and heat is easily generated, and therefore, the benefit of employing the present disclosure is great.

The first internal electrode 21 is preferably electrically connected to ground. Moreover, the second internal electrode 22 and the third internal electrode 23 are preferably electrically connected to different signal lines. Connecting the internal electrodes in such aa way enables the current flowing through the first internal electrode 21 to be further reduced and the surge resistance to be further suppressed from decreasing.

Each of the internal electrodes 21, 22, and 23 may be connected to the external electrode at any surface of the side surfaces and the end surfaces of the sintered compact 11. For example, the first internal electrode 21 is connected to the first external electrode 31 on the side surfaces of the sintered compact 11, the second internal electrode 22 is connected to the second external electrode 32 on one of the two end surfaces facing each other of the sintered compact 11, and the third internal electrode 23 is connected to the third external electrode 33 on the other of the two end surfaces facing each other of the sintered compact 11.

The internal electrodes 21, 22, and 23 include, for example, Ag, Pd, PdAg, PtAg and the like. The internal electrodes 21, 22, and 23 are, for example, formed by stacking ceramic sheets including an internal electrode paste applied thereto such that a thickness of a desired internal electrode is achieved, and sintering the ceramic sheets.

### (External Electrode)

The multilayer varistor 1 includes, for example, as the external electrodes, the first external electrode 31 connected to the first internal electrode 21, the second external electrode 32 connected to the second internal electrode 22, and the third external electrode 33 connected to the third internal electrode 23.

Each of the first external electrode 31, the second external electrode 32, and the third external electrode 33 may be disposed on any surface of the side surfaces and the end surfaces of the sintered compact 11. For example, the first external electrode 31 is disposed on the side surfaces of the sintered compact 11, and the second external electrode 32 and the third external electrode 33 are respectively disposed on one end surface and the other end surface of the two end surfaces facing each other of the sintered compact 11.

The external electrodes 31, 32, and 33 each contain: a metal component such as Ag, AgPd, or AgPt; and a glass component such as Bi₂O₃, SiO₂, or B₂O₅. The external electrodes 31, 32, and 33 preferably contain metal as a main component, and more preferably contain silver as a main component. The external electrodes 31, 32, and 33 can be formed, for example, by transferring a conductive external electrode paste to the surfaces of the sintered compact 11 by a roller.

The first external electrode 31 is preferably electrically connectable to ground, the second external electrode 32 is preferably electrically connectable to a first signal line, and the third external electrode 33 is preferably electrically connectable to a second signal line. In this case, the surge resistance of the multilayer varistor 1 can be further suppressed from decreasing.

The multilayer varistor 1 may have respective plating electrodes covering at least part of the external electrodes 31, 32, and 33. Examples of the plating electrodes include: a Ni electrode disposed to cover at least part of the external electrodes 31, 32, and 33; and a Sn electrode disposed to cover at least part of the Ni electrode.

### Variations

The embodiment described above is a mere example of various embodiments of the present disclosure. The embodiment described above may be modified variously depending on design or the like as long as the object of the present disclosure is achieved.

Variations of the embodiment described above will be described below.

In the multilayer varistor 1 of the embodiment described above, the second internal electrode 22 and the third internal electrode 23 are disposed on different sides of the first internal electrode 21 (see FIG. 1B). However, as in the case of the multilayer varistor 1 shown in FIG. 2, the second internal electrode 22 and the third internal electrode 23 may be disposed on the same side of the first internal electrode 21.

Moreover, in the multilayer varistor 1 of the embodiment described above, all of the first internal electrode 21, the second internal electrode 22, and the third internal electrode 23 overlap one another (see FIG. 1B). However, as in the case of the multilayer varistor 1 shown in FIG. 3, the first internal electrode 21, the second internal electrode 22, and third internal electrode 23 do not all have to overlap one another, and a part of the first internal electrode 21 may overlap only the second internal electrode layer 22, and another part of the first internal electrode 21 may overlap only the third internal electrode layer 23.

The multilayer varistor 1 of the embodiment described above, includes one first internal electrode 21, one second internal electrode 22, and one third internal electrode 23 (see FIG. 1B). However, in the multilayer varistor 1, at least one of the first internal electrode 21, the second internal electrode 22, or the third internal electrode 23 respectively includes a plurality of first internal electrodes 21, a plurality of second internal electrodes 22, or a plurality of third internal electrodes 23. The multilayer varistor 1 of FIG. 4 includes two sets each including the first internal electrode 21, the second internal electrode 22, and the third internal electrode 23 in the stacking direction. Such a structure enables the number of varistor elements of the multilayer varistor 1 to be increased.

### (Recapitulation)

As can be seen from the embodiment and the variations described above, the present disclosure includes the following aspects. In the following description, reference signs in parentheses are provided only to explicitly show a correspondence relationship to the embodiment.

A multilayer varistor (1) of a first aspect includes: a sintered compact (11) including a plurality of layers stacked in a stacking direction; a first internal electrode (21) disposed on a first disposing surface (T1) in the sintered compact (11); a second internal electrode (22) disposed on a disposing surface (T2) different from the first disposing surface (T1) in the sintered compact (11), the second internal electrode (22) overlapping at least part of the first internal electrode (21) in the stacking direction; and a third internal electrode (23) disposed on a disposing surface (T2) different from the first disposing surface (T1) in the sintered compact (11), the third internal electrode (23) overlapping at least part of the first internal electrode (21) in the stacking direction. A length (d1) of the first internal electrode (21) in the stacking direction is greater than a length (d2) of each of the second internal electrode (22) and the third internal electrode (23) in the stacking direction.

The first aspect enables surge resistance of the multilayer varistor to be suppressed from decreasing even when the multilayer varistor receives a plurality of surges at the same time.

In a multilayer varistor (1) of a second aspect referring to the first aspect, the first internal electrode (21) is electrically connected to ground, and the second internal electrode (22) and the third internal electrode (23) are electrically connected to different signal lines.

The second aspect enables a current flowing through the first internal electrode (21) to be reduced and the surge resistance to be further suppressed from decreasing.

In a multilayer varistor (1) of a third aspect referring to the second aspect, the first internal electrode (21) is connected to a first external electrode (31) electrically connectable to ground, the second internal electrode (22) is connected to a second external electrode (32) electrically connectable to a first signal line, and the third internal electrode (23) is connected to a third external electrode (33) electrically connectable to a second signal line.

The third aspect enables the surge resistance of the multilayer varistor (1) to be further suppressed from decreasing.

In a multilayer varistor (1) of a fourth aspect referring to any one of the first to third aspects, the first internal electrode (21) is between the second internal electrode (22) and the third internal electrode (23) in the stacking direction.

The fourth aspect represents a structure in which a current density of the first internal electrode (21) easily increases and heat is easily generated, and therefore, the benefit of employing the present disclosure is great.

In a multilayer varistor (1) of a fifth aspect referring to any one of the first to fourth aspects, at least part of the first internal electrode (21), at least part of the second internal electrode (22), and at least part of the third internal electrode (23) overlap one another in the stacking direction.

The fifth aspect represents a structure in which a current density of the first internal electrode (21) easily increases and heat is easily generated, and therefore, the benefit of employing the present disclosure is great.

In a multilayer varistor (1) of a sixth aspect referring to any one of the first to fifth aspects, the length (d1) of the first internal electrode (21) in the stacking direction is 1.2 or more times and 3 or less times the length (d2) of each of the second internal electrode (22) and the third internal electrode (23) in the stacking direction.

The sixth aspect enables the surge resistance to be suppressed, and in addition, enables elements of the internal electrodes to be further suppressed from warping.

A multilayer varistor (1) of a seventh aspect referring to any one of the first to sixth aspects includes at least one selected from a group consisting of: a plurality of first internal electrodes (21) including the first internal electrode (21); a plurality of second internal electrodes (22) including the second internal electrode (22); and a plurality of third internal electrodes (23) including the third internal electrode (23).

The seventh aspect enables the number of varistor elements in the multilayer varistor (1) to be increased.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein.

1. A multilayer varistor comprising:
a sintered compact including a plurality of layers stacked in a stacking direction;
a first internal electrode disposed on a first disposing surface in the sintered compact;
a second internal electrode disposed on a disposing surface different from the first disposing surface in the sintered compact, the at least one second internal electrode overlapping at least part of the first internal electrode in the stacking direction; and
a third internal electrode disposed on a disposing surface different from the first disposing surface in the sintered compact, the third internal electrode overlapping at least part of the first internal electrode in the stacking direction,
a length of the first internal electrode in the stacking direction being greater than a length of each of the second internal electrode and the third internal electrode in the stacking direction.

2. The multilayer varistor of claim 1, wherein
the first internal electrode is electrically connected to ground, and
the second internal electrode and the third internal electrode are electrically connected to different signal lines.

3. The multilayer varistor of claim 2, wherein
the first internal electrode is connected to a first external electrode electrically connectable to ground,
the second internal electrode is connected to a second external electrode electrically connectable to a first signal line, and
the third internal electrode is connected to a third external electrode electrically connectable to a second signal line.

4. The multilayer varistor of claim 1, wherein
the first internal electrode is between the second internal electrode and the third internal electrode in the stacking direction.

5. The multilayer varistor of claim 2, wherein
the first internal electrode is between the second internal electrode and the third internal electrode in the stacking direction.

6. The multilayer varistor of claim 3, wherein
the first internal electrode is between the second internal electrode and the third internal electrode in the stacking direction.

7. The multilayer varistor of claim 1, wherein
at least part of the first internal electrode, at least part of the second internal electrode, and at least part of the third internal electrode overlap one another in the stacking direction.

8. The multilayer varistor of claim 2, wherein
at least part of the first internal electrode, at least part of the second internal electrode, and at least part of the third internal electrode overlap one another in the stacking direction.

9. The multilayer varistor of claim 3, wherein
at least part of the first internal electrode, at least part of the second internal electrode, and at least part of the third internal electrode overlap one another in the stacking direction.

10. The multilayer varistor of claim 1, wherein
the length of the first internal electrode in the stacking direction is 1.2 or more times and 3 or less times the length of each of the second internal electrode and the third internal electrode in the stacking direction.

11. The multilayer varistor of claim 2, wherein
the length of the first internal electrode in the stacking direction is 1.2 or more times and 3 or less times the length of each of the second internal electrode and the third internal electrode in the stacking direction.

12. The multilayer varistor of claim 3, wherein
the length of the first internal electrode in the stacking direction is 1.2 or more times and 3 or less times the length of each of the second internal electrode and the third internal electrode in the stacking direction.

13. The multilayer varistor of claim 1, comprising at least one selected from a group consisting of:
a plurality of first internal electrodes including the first internal electrode; a plurality of second internal electrodes including the second internal electrode; and a plurality of third internal electrodes including the third internal electrode.

14. The multilayer varistor of claim 2, comprising at least one selected from a group consisting of:
a plurality of first internal electrodes including the first internal electrode; a plurality of second internal electrodes including the second internal electrode; and a plurality of third internal electrodes including the third internal electrode.

15. The multilayer varistor of claim 3, comprising at least one selected from a group consisting of:
a plurality of first internal electrodes including the first internal electrode; a plurality of second internal electrodes including the second internal electrode; and a plurality of third internal electrodes including the third internal electrode.
